(19) United States
(12) Patent Application Publication
(10) Pub. No.: US 2022/0337547 A1
(43) Pub. Date: Oct. 20, 2022

(54) DOMAIN ROUTING FOR PRIVATE NETWORKS

(71) Applicant: OpenVPN, Inc., Pleasonton, CA (US)

(72) Inventors: Francis Dinha, Pleasonton, CA (US); James Yonan, Pleasonton, CA (US)

(21) Appl. No.: 17/714,453

(22) Filed: Apr. 6, 2022

Related U.S. Application Data
(60) Provisional application No. 63/174,933, filed on Apr. 14, 2021.

(51) Int. Cl. H04L 61/4511; H04L 9/40; H04L 61/4535; H04L 61/30

(52) U.S. Cl. CPC H04L 61/4511; H04L 63/0272; H04L 61/4535; H04L 61/30

(57) ABSTRACT

Methods for creating an ultra-lightweight multi-tenant network virtualization model by augmenting an OSI layer 4 tuple (protocol, source IP address, destination IP address, source port, destination port) with additional private gateway-specific source and destination augmented addresses. A unique OpenVPN Augmented Address (OAA) may be created and assigned to each device on a network such as a mesh-linked system. This OAA may form part of a packet shim created with routing path information for both the source and the destination resources. Once created, the shim may be inserted into a packet header for transmission. The packet shim operates to establish a communications session on layer 4 (Transport) between the requestor and the target resource which is intermediate-device agnostic. Further disclosed are methods for intelligently routing domain-level traffic to VPNs including augmenting a DNS with VPN information associated with human-memorable domain names.

### PRIORITY

The application claims the benefit of co-pending provisional patent application No. 63/174,933 filed Apr. 14, 2021, by the same inventors, which is incorporated by reference as if fully set forth herein.

### BACKGROUND

Conventionally, an enterprise-wide communications system can implement security measures with layered security such as firewalls, gateway security agents, and the like. However, such layered security systems are prone to processing inefficiencies and can require many resources within the enterprise to maintain the systems. In such a distributed security system, an enterprise can transmit data to and receive data from the distributed security system by use of tunneling technologies. A tunneling protocol enables one network protocol (the delivery protocol) to encapsulate packets that conform to a payload protocol to carry a payload over an incompatible delivery network or can provide a secure path through an open network. Example tunneling technologies include virtual private network (VPN) routers and VPN concentrators can be used to achieve the traffic redirection for tunneling.

The use of tunneling, however, presents the enterprise and the security provider with specific challenges and problems. For example, a split tunnel allows a virtual private network (VPN) user to forward some but not all of their data over one or more private VPN tunnels. Consider for example, a corporate VPN for employees of mycompany.com. In a traditional split-tunnel VPN, only certain IP address ranges corresponding to internal corporate services would be forwarded over the secure VPN tunnel. Other data traffic, such as traffic to internet news, e-commerce, social networking sites, etc. would be unaffected, and would be routed over the user's standard internet connection.

But conventional split-tunnel VPN has at least one key shortcoming, for example, and without limitation, the requirement that the IP address ranges for all corporate services accessible by the VPN be known in advance and be pushed to the user's client device as a set of routes. This is a cumbersome process that requires the low-level management of IP addresses and routes.

### SUMMARY

Disclosed herein are methods for domain routing that allow a VPN administrator to specify services to be routed over the VPN as a set of high-level, human-readable domains. For example, in the case of mycompany.com, suppose that the network administrator cordons off a set of services under an internal domain called internal.mycompany.com. With domain routing, configuring a split-tunnel becomes as simple as specifying that only traffic to internal.mycompany.com and subdomains should be routed through the tunnel.

Also disclosed is a method for creating an ultra-lightweight multi-tenant network virtualization model by augmenting an OSI layer 4 tuple (protocol, source IP address, destination IP address, source port, destination port) with additional private gateway-specific source and destination augmented addresses. A unique OpenVPN Augmented Address (OAA) may be created and assigned to each device on a network such as a mesh-linked system. This OAA may form part of a packet shim created with routing path information for both the source and the destination resources. Once created, the shim may be inserted into a packet header for transmission. The packet shim operates to establish a communications session on layer 4 (Transport) between the requestor and the target resource which is intermediate-device agnostic. Further disclosed are methods for intelligently routing domain-level traffic to VPNs.

The objects of this domain routing include, but are not limited to the following advantages over conventional split tunnel routing:

Domain routes may be specified as domains without regard for the underlying IP address. For example, one could specify that salesforce.com should be routed through the VPN, and that would cause not only salesforce.com but all subdomains of salesforce.com (such as https://support.salesforce.com) to be routed through the VPN tunnel.

Domain routes may be specified as dynamic domains, where the underlying IP address(es) of the domain are dynamic and subject to change.

Domain routes may be specified for external public sites (such as www.salesforce.com) rather than merely for internal corporate services.

Access control rules may be defined by the VPN administrator in terms of domains rather than IP addresses.

Domain routes may be used to create access control whitelists or blacklists, where an outgoing layer 4 session to an IP address will be blocked unless that IP address was previously returned by an allowed domain lookup.

Domain routing, like standard IP routing, may route sessions at OSI layer 3, which means that secure TLS sessions can be forwarded end-to-end without an intermediate decryption step at the VPN server.

### BRIEF DESCRIPTION OF THE DRAWINGS

FIG. 1 illustrates a flow chart of steps, some of which, may be employed in certain embodiments.

FIG. 2 illustrates another method which may be employed in some embodiments.

### DESCRIPTION

### Generality of Invention

This application should be read in the most general possible form. This includes, without limitation, the following:

References to specific techniques include alternative and more general techniques, especially when discussing aspects of the invention, or how the invention might be made or used.

References to “preferred” techniques generally mean that the inventor contemplates using those techniques, and thinks they are best for the intended application. This does not exclude other techniques for the invention, and does not mean that those techniques are necessarily essential or would be preferred in all circumstances.

References to contemplated causes and effects for some implementations do not preclude other causes or effects that might occur in other implementations.

References to reasons for using particular techniques do not preclude other reasons or techniques, even if completely contrary, where circumstances would indicate that the stated reasons or techniques are not as applicable.

Furthermore, the invention is in no way limited to the specifics of any particular embodiments and examples disclosed herein. Many other variations are possible which remain within the content, scope and spirit of the invention, and these variations would become clear to those skilled in the art after perusal of this application.

Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Read this application with the following terms and phrases in their most general form. The general meaning of each of these terms or phrases is illustrative, not in any way limiting.

### Lexicography

The term “client” generally refers to a VPN user who may be trying to access protected content.

The term “connector” generally refers to a service (such as a web service) that exports protected content subject to one or more factors of user authentication.

The terms “name server” or “domain name server” generally refers to a server which translates or resolves human-memorable domain names (i.e. example.com) and hostnames into the corresponding numeric Internet Protocol (IP) addresses (i.e. 93.184.216.34).

The term “Static Resource” generally refers to a networked resource provided by a connector.

The term “resource” generally refers to a routing target uniquely namespaced for a particular environment.

The term “dynamic resource” generally refers to a fully-meshed access model, where all clients both export and consume a resource. In this model, each client joins a mesh and can interact with any other client over the mesh.

The term “virtual private network (VPN) generally refers to a network system that enables users to send and receive data across shared or public networks as if their computing devices were directly connected to a private network. VPN may operate by encryption and encapsulation of data packets before transmitting.

### DETAILED DESCRIPTION

### Augmented Addressing

In some embodiments an ultra-lightweight multi-tenant network virtualization model may be effectuated by augmenting an OSI layer 4 tuple (i.e. protocol, source IP address, destination IP address, source port, destination port) with additional private gateway-specific source and destination augmented addresses. A unique OpenVPN Augmented Address (OAA) may be created and assigned to each device on a network such as a mesh-linked system. This OAA may form part of a packet shim created with routing path information for both the source and the destination resources. Once created, the shim may be inserted into a packet header for transmission. Once the initial packet is transmitted, each hop creates its own resources for managing transmission of subsequent packets in this session. The packet shim operates to establish a communications session on layer 4 (Transport) between the requestor and the target resource which is intermediate-device agnostic.

Accordingly, certain embodiments may effectuate a private gateway model by assigning a local 32-bit identifier (ID) to each VPN client or connector connected to a private gateway node. This identifier may be an OpenVPN Augmented Address (OAA). An OAA uniquely identifies an VPN client connected to a private gateway node. The OAA may be unique on the private gateway node itself. Details on OpenVPN augmented addressing may be found on U.S. Patent Application 63/049,287 by the same inventors, which is included by reference as if fully set forth herein.

Some embodiments mesh a cluster of private gateway nodes together using mesh links, wherein each private gateway node is interconnected with every other private gateway node with one or more mesh links. The mesh links themselves may be constructed from VPN sessions and each end of a mesh link may also be assigned a locally unique OAA.

When a client requests access to a resource, the request is processed by the private gateway node that the client is directly connected to. The private gateway node operates as a facilitator of the request (the first-hop private gateway node). The private gateway node then queries a distributed resource database to create a packet shim that may define a sequence of routing hops to reach a designated target resource. The packet shim header may be inserted at the head of the packet.

When the very first packet of a session is constructed by the first-hop private gateway node, the private gateway node prepends the routing path shim to the IP packet cleartext (before encryption). Since each client, connector, or mesh link is assigned an OAA, it becomes possible to specify the routing path for a session as a sequence (or stack) of OAAs. Then the routing model operates by each hop popping the next-hop OAA address off the top of the stack and forwarding the remaining session packet to the next hop.

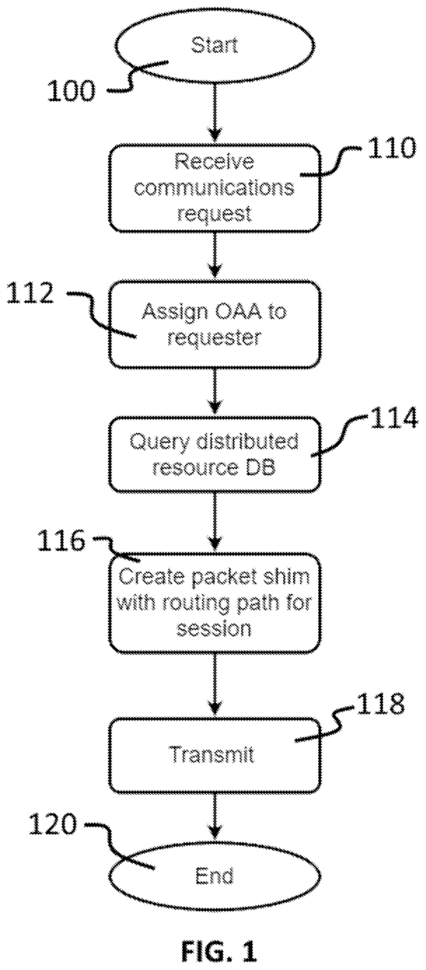

FIG. 1 illustrates a flow chart of steps, some of which may be employed in certain embodiments of augmented addressing. Not every step is required in every embodiment and the order of steps may be different in different embodiments. The method starts at a flow label 100.

At a step 110 a server receives a communications request. The server may be connected to a network and include processor instructions operable to function as a private gateway node.

At a step 112 an OAA is assigned to the requestor. The OAA may be unique either to a local cluster or globally.

At a step 114 the server queries a distributed resource database to determine the location of the target of the communications request.

At a step 116 a packet shim is created with routing path information for the communications and inserted into a packet header.

At a step 118 the communication is transmitted to the first hop in the routing path.

At a flow label 120 the method ends.

The packet shim of step 116 operates to establish a communications session on layer 4 (Transport) between the requestor and the target resource. Once the session is created, two-way communications are effectuated because intermediate steps, such as routers, operate on internal routing maps.

### Domain Routing

The implementation of domain routing may begin by employing a custom domain name server (DNS) that responds to DNS queries from VPN clients. Since domain routing may be implemented as a multi-tenant service, the first step in processing a DNS request from a VPN client is generally to identify which client/tenant the DNS request is coming from. In some embodiments this may be done by examining the request and extracting the source OpenVPN Augmented Address (OAA) which uniquely identifies the VPN client/tenant making the request. Once the client/tenant is known, the DNS Server is enabled to look up the configuration for the client/tenant in a database or other structured data store.

The known configuration will contain a list of domains which should be subject to domain routing, as well as an access control list (ACL) and routing table that can be used to filter or route traffic by domain to a destination connector (a connector is a physical or virtual machine that exports one or more services via a secure VPN link).

The domain-routing-aware DNS server may then parse the DNS request message and based on information in the client/tenant configuration, determine whether the domain is subject to domain routing. If not, the DNS server will forward the request to the upstream resolver like a conventional proxy.

However, if the domain is subject to domain routing, the DNS server (after receiving a list of IP addresses from the upstream resolver) will perform an aliasing operation, where the returned IP addresses are reversibly transformed into a different set of addresses that match a unique private address range (known as the aliasing range) that has been pre-pushed to the VPN client to facilitate domain routing. These aliased addresses (instead of the original addresses returned by the upstream resolver) will then be returned to the DNS client to satisfy the query, however because the transform must be reversible, the DNS server will also store the original addresses for later use.

When the application running on the VPN client device (or gatewayed by it) opens up an OSI layer 4 session (such as a TCP or UDP session) to the aliased address, the session will be routed via the secure VPN tunnel, since the aliasing range has already been pre-pushed to the VPN client as a routable subnet. Since the application layer has opened up a session to the aliased address (returned by the DNS query), the VPN server will intercept the session, identify the aliased address, and cross reference it back to the domain that was aliased. This allows the original alias transform to be reversed back to the original address, and this original address is then used as the target of a destination network address translation (DNAT) transform to allow the layer 4 session to reach the correct destination.

The alias transform and its subsequent reversal steps may operate in tandem to effectuate certain embodiments. On the client side, the alias transform allows traffic to be easily classified into route or don't route via the VPN tunnel. On the server side, the alias address may allow a fast hash-table lookup to identify the domain and make that information available to the ACL rule matcher, as well as the original IP address, so the alias transform can be properly reversed.

References in the specification to “one embodiment”, “an embodiment”, “an example embodiment”, etc., indicate that the embodiment described may include a particular feature, structure or characteristic, but every embodiment may not necessarily include the particular feature, structure or characteristic. Moreover, such phrases are not necessarily referring to the same embodiment. Further, when a particular feature, structure or characteristic is described in connection with an embodiment, it is submitted that it is within the knowledge of one of ordinary skill in the art to effectuate such feature, structure or characteristic in connection with other embodiments whether or not explicitly described. Parts of the description are presented using terminology commonly employed by those of ordinary skill in the art to convey the substance of their work to others of ordinary skill in the art.

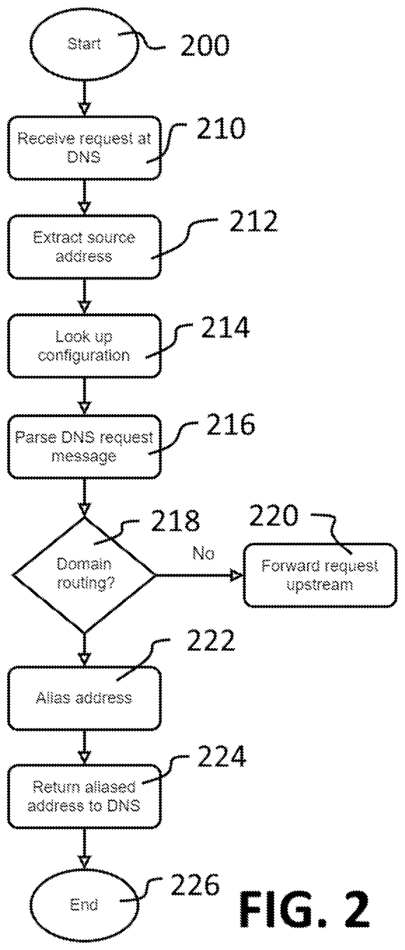

FIG. 2 illustrates another method which may be employed in some embodiments. In FIG. 2 the method starts at a flow label 200. At a step 210 a DNS receives a request from a VPN client.

At a step 212 the source (client) address is extracted from the request, and at a step 214 the configuration for that client is read from a data store based on the source address.

At a step 216 the DNS request message is parsed and based on information in the client/tenant configuration, a determination whether the domain is subject to domain routing is performed at a step 218.

If the domain is not subject to domain routing, the method proceeds to a step 220 where the request is forwarded upstream like a conventional proxy.

However, if the domain is subject to domain routing, the DNS server (after receiving a list of IP addresses from the upstream resolver) will perform an aliasing operation at a step 222, wherein the returned IP addresses are reversibly transformed into a different set of addresses that match a unique private address range (known as the aliasing range) that has been pre-pushed to the VPN client to facilitate domain routing. The DNS server will also store the original addresses for future use.

At a step 224 the now aliased address is returned to the DNS.

At a flow label 226 the method ends.

### Domain Routing Embodiments

One example of how domain routing may be implemented can be seen in the following example. The examples presented herein are for illustrative purposes only and should not be construed as limiting this disclosure in any way. In this first example, a VPN administrator would like to configure a particular VPN user to establish a split tunnel where only amazonaws.com and its subdomains are routed through the VPN tunnel. The VPN administrator would edit the user's configuration to specify two configuration settings:

split_tunnel_subnet: “10.9.0.0/16”—This setting creates a pool of IP addresses (10.9.0.0 to 10.9.255.255) used to alias DNS lookups for domains that have been configured to route through the VPN tunnel (the “aliased_domains”). Aliasing is the process where the IP address returned from a DNS query is remapped onto the split_tunnel_subnet before being returned to the client.

aliased_domains: [“amazonaws.com”]—This setting indicates a list of one or more domains that have been configured to route through the VPN tunnel.

When the VPN user connects to the VPN, the VPN server may temporarily (while the VPN session is active) override the DNS server IP addresses on the user's VPN client device to point to the VPN server's own integrated DNS server (the PG-DNS). This may provide the VPN server full control over domain resolution queries while the VPN session is active.

The VPN server will also push a route to the client device telling it that all references to IP addresses in the split_tunnel_subnet (“10.9.0.0/16”) should be routed through the VPN tunnel, but that IP address references outside this subnet should be routed directly via the user's ISP, bypassing the VPN tunnel. After this route is pushed, the split_tunnel_subnet (“10.9.0.0/16”) route can be observed on the client (see table 1 italics):

TABLE 1
Kernel IP Routing Table
$ route -n

| Destination | Gateway | Genmask | Flags | Metric | Ref | Use | Iface |
|---|---|---|---|---|---|---|---|
| 0.0.0.0 | 10.10.0.1 | 0.0.0.0 | UG | 100 | 0 | 0 | enx8cae4ce90d1e |
| 1.2.3.0 | 10.212.0.1 | 255.255.255.0 | UG | 0 | 0 | 0 | tun |
| 7.7.7.0 | 10.212.0.1 | 255.255.255.0 | UG | 0 | 0 | 0 | tun |
| 8.8.8.8 | 10.212.0.1 | 255.255.255.255 | UGH | 0 | 0 | 0 | tun |
| 10.9.0.0 | 10.212.0.1 | 255.255.0.0 | UG | 0 | 0 | 0 | tun |
| 10.10.0.0 | 0.0.0.0 | 255.255.255.0 | U | 100 | 0 | 0 | enx8cae4ce90d1e |
| 10.42.0.0 | 10.212.0.1 | 255.255.0.0 | UG | 0 | 0 | 0 | tun |
| 10.212.0.0 | 0.0.0.0 | 255.255.0.0 | U | 0 | 0 | 0 | tun |
| 111.112.113.0 | 10.212.0.1 | 255.255.255.0 | UG | 0 | 0 | 0 | tun |
| 169.254.0.0 | 0.0.0.0 | 255.255.0.0 | U | 1000 | 0 | 0 | virbr0 |
| 192.168.4.0 | 0.0.0.0 | 255.255.255.0 | U | 0 | 0 | 0 | br0 |
| 192.168.122.0 | 0.0.0.0 | 255.255.255.0 | U | 0 | 0 | 0 | virbr0 |

In operation, when a user of the VPN client accesses the domain s3.amazonaws.com, the user's client device will perform a DNS query on s3.amazonaws.com via the VPN server's integrated DNS server (the PG-DNS). This query is routed over the VPN tunnel to PG-DNS, which will intercept the DNS query from the client to s3.amazonaws.com, and if the query is marked by the Augmented Address (OAA) of the client, PG-DNS is able to determine which VPN user the DNS query is being made on behalf of, and look up that user's configuration (for example, client OAA=7999). The user's configuration will define the aliased_domains list, and PG-DNS will perform an algorithm to determine if the DNS query (s3.amazonaws.com) matches any subdomain in the list. In this example it does because s3.amazonaws.com is a subdomain of amazonaws.com. Since the match is positive, after PG-DNS contacts its upstream resolver to query the A/AAAA DNS records of s3.amazonaws.com, it will perform an aliasing transform on the returned IP addresses.

Under normal conditions, without an aliasing transform, a DNS lookup on s3.amazonaws.com might return a result such as this:

$ host s3.amazonaws.com

s3.amazonaws.com has address 52.216.240.166 However, with the aliasing transform in effect, PG-DNS will remap 52.216.240.166 onto the split_tunnel_subnet documented above (“10.9.0.0/16”). This mapping may be stored in an internal hash table (an “alias_table”) that is keyed by the tuple of the client OAA, alias IP address. The result returned to the client will reflect an alias transform:

$ host s3.amazonaws.com

s3.amazonaws.com has address 10.9.49.72

Note that the aliasing transform has remapped 52.216.240.166 to 10.9.49.72. Now, it will appear to the client that s3.amazonaws.com is reachable via the IP address 10.9.49.72 and will attempt to establish an OSI layer 4 session with it (such as a TCP session). However, because 10.9.49.72 is a member of the split_tunnel_subnet (10.9.0.0/16), the session will be routed via the VPN tunnel.

The alias_table we established above will now have an entry:

(7999, 10.9.49.72)→52.216.240.166

This entry will allow us to identify the OSI layer 4 session initiated by the client to the aliased address, allowing us to “un-alias” the transform via a destination-NAT operation (DNAT) at the Connection Tracking layer within the OS network stack.

In certain embodiments, when the VPN server identifies a layer 4 session with OAA 7999 to destination IP address 10.9.49.72, it will query the alias_table to statefully and reversibly rewrite the destination address of the session to the original IP address 52.216.240.166, allowing it to reach the intended destination of s3.amazonaws.com. This stateful, reversible rewrite of the destination IP address may be referred to as Destination-NAT or DNAT.

This example may employ an alias transform as a domain-centric split tunnel that selectively forces some domains through the VPN tunnel while others bypass it, all controlled by a simple route on the client (i.e. “10.9.0.0/16”).

As another example embodiment, a domain is resolved (google.com) where traffic to this domain should NOT be routed through the tunnel. Similar to the s3.amazonaws.com example, however, when PG-DNS performs the algorithm to determine if the DNS query (google.com) matches any subdomain in the aliased_domains list, it will fail to match because google.com is NOT a subdomain of any domain in this list. Since the match is negative, PG-DNS will return the actual IP address of google.com to the VPN client rather than an aliased version of the address.

$ host google.com

google.com has address 172.217.164.142

Since the returned address falls outside the split_tunnel_subnet (“10.9.0.0/16”), the OSI Layer 4 session to this address will be routed directly to the destination, bypassing the VPN tunnel.

Certain embodiments may include a method for improving electronic communications including creating a domain name server (DNS) with a structured data store, including at least a unique address field, an alias field, a non-alias field, and a domain name. The method may further include receiving a DNS request having a unique address information and a domain name information. Such that the DNS queries the structured data store in response to the DNS request and returns either an alias information or a non-alias information in response to said querying. wherein said alias information includes virtual private network address information.

In one embodiment the unique address information identifies a remote device coupled to the DNS, and the alias information includes a uniform resource locator (URL) associated with a virtual private network. The structured data store may also include an augmented address information, wherein the DNS either returns an alias information or a non-alias information is in response to the augmented address information.

The above illustration provides many different embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and, in a manner, consistent with the scope of the invention, as set forth in the following claims.

What is claimed is:

1. A method for improving electronic communications including:
creating a domain name server (DNS) said DNS including a structured data store, said structured data store including at least a unique address field, an alias field, a non-alias field, and a domain name;
receiving a DNS request, said request including a unique address information and a domain name information;
querying the structured data store in response to the DNS request, and
returning either an alias information or a non-alias information in response to said querying,
wherein said alias information includes virtual private network address information.

2. The method of claim 1 wherein the unique address information identifies a remote device coupled to the DNS.

3. The method of claim 1 wherein the alias information includes a uniform resource locator (URL) associated with a virtual private network.

4. The method of claim 1 wherein the structured data store includes an augmented address information, and the DNS request includes and augmented address information.

5. The method of claim 4 wherein said returning either an alias information or a non-alias information is in response to the augmented address information.

6. A method for improving digital communications including:
creating a domain name server (DNS), said DNS including a structured data store, said data store including a predetermined list of aliased domains, said list of aliased domains including an alias address information indicative of virtual private network (VPN) routing;
receiving, at the DNS, a DNS request;
querying the structured data store in response to the DNS request, and
returning an internet protocol (IP) address associated with VPN routing.

7. The method of claim 6 wherein the structured data store includes both aliased domains and non-aliased domains.

8. The method of claim 6 wherein the IP address is one of a split tunnel subnet.

9. The method of claim 6 wherein the structured data store includes an augmented address information, and the DNS request includes and augmented address information.

10. The method of claim 9 wherein said returning an IP address associated with VPN routing IP is in response to the augmented address information.

11. One or more processor-readable storage devices, said devices including non-transitory instructions directing a processor to perform a methods including:
creating a domain name server (DNS), said DNS including a structured data store, said data store including a predetermined list of aliased domains, said list of aliased domains including an alias address information indicative of virtual private network (VPN) routing;
receiving, at the DNS, a DNS request;
querying the structured data store in response to the DNS request, and
returning an internet protocol (IP) address associated with VPN routing.

12. The devices of claim 11 wherein the structured data store includes both aliased domains and non-aliased domains.

13. The devices of claim 11 wherein the IP address is one of a split tunnel subnet.

14. The devices of claim 11 wherein the structured data store includes an augmented address information, and the DNS request includes and augmented address information.

15. The devices of claim 14 wherein said returning an IP address associated with VPN routing IP is in response to the augmented address information.
